(19) United States
(12) Patent Application Publication
(10) Pub. No.: US 2018/0066152 A1
(43) Pub. Date: Mar. 8, 2018

(54) HARD COATING FILM AND IMAGE DISPLAY DEVICE HAVING THE SAME

(71) Applicant: DONGWOO FINE-CHEM CO., LTD., Iksan-si (KR)

(72) Inventors: Seungwoo LEE, Hwaseong-si (KR); Min Kyung KANG, Suwon-si (KR); Donghwi KIM, Sejong-si (KR)

(73) Assignee: DONGWOO FINE-CHEM CO., LTD., Iksan-si (KR)

(21) Appl. No.: 15/689,004

(22) Filed: Aug. 29, 2017

(30) Foreign Application Priority Data
Sep. 5, 2016 (KR) 10-2016-0113948
Mar. 8, 2017 (KR) 10-2017-0029333

(51) Int. Cl. C09D 133/08; C09D 163/00; C09D 7/12; C09D 7/06; C09D 183/04; G02B 1/14

(52) U.S. Cl. CPC C09D 133/08; C09D 163/00; C09D 7/1216; C08K 3/36; C09D 183/04; G02B 1/14; C09D 7/06

(57) ABSTRACT

The present invention provides a hard coating film in which a first hard coating layer and a second hard coating layer are laminated on one side of a substrate film, wherein, AB<0 when the curl values of the first hard coating layer and the second hard coating layer are A and B, respectively. The hard coating film according to the present invention can minimize the occurrence of curling while having excellent bending resistance and scratch resistance.

### CROSS REFERENCE TO RELATED APPLICATIONS

This application claims priority based on Korean Patent Application No. 10-2016-0113948, filed Sep. 5, 2016 and Korean Patent Application No. 10-2017-0029333, filed Mar. 8, 2017, the contents of which are incorporated herein by reference in their entirety.

### TECHNICAL FIELD

The present invention relates to a hard coating film and an image display device having the same. More particularly, the present invention relates to a hard coating film capable of minimizing the occurrence of curling while having excellent bending resistance and scratch resistance, and to an image display device having the hard coating film.

### BACKGROUND ART

A hard coating film has been used for protecting the surface of various image displays including a liquid crystal display device (LCD), an electroluminescence (EL) display device, a plasma display (PD), a field emission display (FED) and the like.

Recently, a flexible display device which can maintain display performance even when it is bent like a paper by using a flexible material such as plastic, instead of a conventional glass substrate having no flexibility, gains attention as a next generation display device. In this regard, there is a need for a hard coating film which not only has high hardness and good scratch resistance but also has proper flexibility so that cracks do not occur, without curling at the film edges during its production or use.

Korean Patent Application Publication No. 10-2016-0057221 discloses a high hardness hard coating film formed by using a hard coating composition including an epoxy siloxane resin having a weight average molecular weight of 800 to 30,000, a crosslinking agent containing a compound having an epoxy cyclohexane structure, and a photopolymerization initiator.

However, in the case of such a hard coating composition with high hardness, there was a problem that bending resistance and/or scratch resistance are not sufficient and curling occurs.

### DISCLOSURE

### Technical Problem

It is an object of the present invention to provide a hard coating film capable of suppressing the occurrence of curling while having excellent bending resistance and scratch resistance.

It is another object of the present invention to provide an image display device having the hard coating film.

### Technical Solution

In accordance with one aspect of the present invention, there is provided a hard coating film in which a first hard coating layer and a second hard coating layer are laminated on one side of a substrate film, wherein, AB<0 when the curl values of the first hard coating layer and the second hard coating layer are A and B, respectively.

In one embodiment of the present invention, the first hard coating layer may be formed from a first hard coating composition including a photocurable acrylic resin, a photopolymerization initiator and a solvent, and the second hard coating layer may be formed from a second hard coating composition including a photocurable epoxy resin, a photopolymerization initiator and a solvent.

In one embodiment of the present invention, the first hard coating layer may be formed from a first hard coating composition including a dendrimer compound having a terminal (meth)acrylate group, a monofunctional (meth)acrylate, a photopolymerization initiator and a solvent, and the second hard coating layer may be formed from a second hard coating composition including an alkoxysilane compound or polysiloxane resin having an epoxy group, a photopolymerization initiator, and a solvent.

In accordance with another aspect of the present invention, there is provided an image display device having the hard coating film.

### Advantageous Effects

The hard coating film according to the present invention can minimize the occurrence of curling while having excellent bending resistance and scratch resistance, and thereby it can be effectively used for a window of a flexible display device.

### BEST MODEL

Hereinafter, the present invention will be described in more detail.

One embodiment of the present invention relates to a hard coating film in which a first hard coating layer and a second hard coating layer are laminated on one side of a substrate film, wherein, AB<0 when the curl values of the first hard coating layer and the second hard coating layer are A and B, respectively.

In one embodiment of the present invention, the curl values of the first hard coating layer and the second hard coating layer are values which are measured after the first hard coating layer or the second hard coating layer is laminated each individually on a substrate film.

The curl value can be obtained by cutting the hard coating film into a size of 10 cm×10 cm, leaving to stand under conditions of 25° C. and 48 RH % for 24 hours, placing the film so that the convex surface thereof is in contact with a reference surface, and then measuring the average of the heights from the reference surface to four edges. The positive curl is represented by (+) value, and the reverse curl is represented by (−) value.

When the hard coating film has been located so that the surface of the substrate film faces a reference surface, the positive curl is a curl having a concave pattern on the surface of the hard coating layer located on the opposite side of the substrate film, and the reverse curl is a curl having a convex pattern on the surface of the hard coating layer.

Therefore, the AB<0 indicates that one of the curl values of the first hard coating layer and the second hard coating layer is (+) value and the remaining one is (−) value. That is, any one of the first hard coating layer and the second hard coating layer has a positive curl, and the remaining one has a reverse curl.

The hard coating film according to one embodiment of the present invention satisfies the condition where the multiplication of the curl values of the first hard coating layer and the second hard coating layer is smaller than 0 (that is, AB<0), thereby suppressing the occurrence of curling.

In the hard coating film according to an embodiment of the present invention, the curl value of the first hard coating layer may be (+) and the curl value of the second hard coating layer may be (−). At this time, the occurrence of curling can be minimized.

The hard coating film according to an embodiment of the present invention can be produced by coating the hard coating composition on one side of a substrate film followed by curing to sequentially form a first hard coating layer and a second hard coating layer.

In the hard coating film according to one embodiment of the present invention, any one of a first hard coating composition or a second hard coating composition described below is used to form a first hard coating layer, and the remaining one hard coating composition is used to form a second hard coating layer. For example, the first hard coating layer may be formed from the first hard coating composition, and the second hard coating layer may be formed from the second hard coating composition.

As the substrate film, any polymer film having transparency can be used. The polymer film can be produced by a film-forming method or an extrusion method according to a molecular weight and a production method of a film, and can be used without limitation as long as it is a commercially available transparent polymer film. Examples thereof include various transparent polymer substrates such as triacetyl cellulose, acetyl cellulose butyrate, ethylene-vinyl acetate copolymer, propionyl cellulose, butyryl cellulose, acetyl propionyl cellulose, polyester, polystyrene, polyamide, polyether imide, polyacryl, polyimide, polyether sulfone, polysulfone, polyethylene, polypropylene, polymethyl pentene, polyvinyl chloride, polyvinylidene chloride, polyvinyl alcohol, polyvinyl acetal, polyether ketone, polyether ether ketone, polyether sulfone, polymethyl methacrylate, polyethylene terephthalate, polybutylene terephthalate, polyethylene naphthalate, polycarbonate, and the like.

The thickness of the substrate film is not particularly limited, but may be 10 to 1000 μm, preferably 20 to 150 μm. When the thickness of the substrate film is less than 10 μm, the strength of the film is lowered and thus the workability is lowered. When the thickness of the substrate film is more than 1000 μm, the transparency is lowered or the weight of the hard coating film is increased.

The first hard coating layer and the second hard coating layer may have a thickness of 1 to 10 μm, respectively. When the thicknesses of the first hard coating layer and the second hard coating layer are less than 1 μm, respectively, it may be difficult to ensure hardness. If the thicknesses are more than 10 μm, the bending resistance may be lowered or the curling may severely occur.

<First Hard Coating Composition>

In one embodiment of the present invention, the first hard coating composition may include a photocurable acrylic resin, a photopolymerization initiator and a solvent,

The photocurable acrylic resin may include at least one selected from the group consisting of a dendrimer compound having a terminal (meth)acrylate group and a monofunctional (meth)acrylate.

In one embodiment of the present invention, the dendrimer compound having a terminal (meth)acrylate group can be used for ultraviolet curing by substituting the terminal of the branched structure with a (meth)acrylate group, and has a structural characteristic that its center is completely aliphatic and composed of a tertiary ester bond. Therefore, the dendrimer compound having a terminal (meth)acrylate group has a structural characteristic that it has more functional groups relative to the molecular weight with an increase in the generation, as compared with a general polyfunctional acrylate monomer. As the functional groups are distributed at the terminal, the core portion can contribute to improve the bending property during its curing. Thereby, a hard coating film having high hardness and improved curl property and flexibility can be obtained.

The dendrimer compound having the terminal (meth)acrylate group may be represented by the following chemical formula 1:

[R₁]₄₋ₙ—C—[R₂—OR₃]ₙ [Chemical Formula 1]

wherein,

R₁ is C₁-C₆ alkyl group,

R₂ is C₁-C₆ alkylene group,

R₃ is a (meth)acryloyl group or

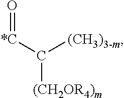

and at least one R₃ is

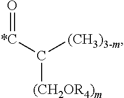

R₄ is a (meth)acryloyl group or

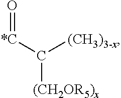

and at least one R₄ is

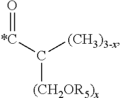

R₅ is a (meth)acryloyl group or

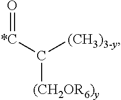

R₆ is a (meth)acryloyl group,

n is an integer of 2 to 4, and

m, x and y are an integer of 2 or 3.

The C₁-C₆ alkyl group as used herein refers to a linear or branched monovalent hydrocarbon having 1 to 6 carbon atoms, and examples thereof include methyl, ethyl, n-propyl, i-propyl, n-butyl, i-butyl, t-butyl, n-pentyl, n-hexyl, and the like, but are not limited thereto.

The C₁-C₆ alkylene group as used herein refers to a linear or branched divalent hydrocarbon having 1 to 6 carbon atoms, and examples thereof include methylene, ethylene, propylene, butylene, and the like, but are not limited thereto.

In one embodiment of the present invention, the dendrimer compound having the terminal (meth)acrylate group may typically have a structure represented by the following chemical formula 2:

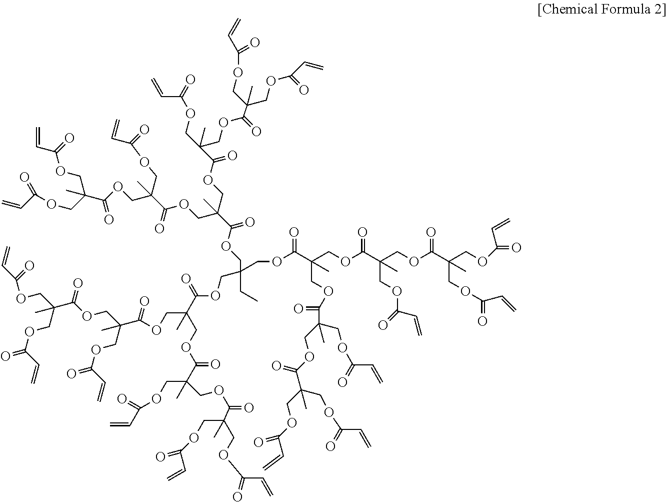 [SMILES: C=CC(=O)OCC(C)(COC(=O)C=C)C(=O)OCC(C)(COC(=O)C=C)C(=O)OCC(C)(COC(=O)C(C)(COC(=O)C=C)COC(=O)C(C)(COC(=O)C=C)COC(=O)C=C)C(=O)OCC(CC)(COC(=O)C(C)(COC(=O)C(C)(COC(=O)C=C)COC(=O)C(C)(COC(=O)C=C)COC(=O)C=C)COC(=O)C(C)(COC(=O)C=C)COC(=O)C(C)(COC(=O)C=C)COC(=O)C=C)COC(=O)C(C)(COC(=O)C(C)(COC(=O)C=C)COC(=O)C(C)(COC(=O)C=C)COC(=O)C=C)COC(=O)C(C)(COC(=O)C=C)COC(=O)C(C)(COC(=O)C=C)COC(=O)C=C]

The dendrimer compound having the terminal (meth)acrylate group is commercially available or can be prepared according to methods known in the art. For example, the highly branched dendrimer compound whose terminals are substituted with a plurality of (meth)acrylate groups can be obtained by condensation-reacting a central skeleton of a specific polyhydric alcohol with dimethylol propionic acid to form a first-generation dendrimer structure, repeatedly condensation-reacting the dimethylol propionic acid as branch structures to grow to a second- or higher generation dendrimer structure, and then condensation-reacting acrylic acids at the terminal.

The dendrimer compound may be contained in an amount of 30 to 60% by weight, preferably 35 to 55% by weight based on 100% by weight of the total weight of the first hard coating composition. When the amount of the dendrimer compound is lower than 30% by weight, it may be difficult to exhibit the bending property, and when the amount of the dendrimer compound is more than 60% by weight, it may be difficult to impart the hardness characteristics to the coating layer due to the presence of unreacted functional groups resulting from the steric hindrance effect.

In one embodiment of the present invention, the monofunctional (meth)acrylate may be used for ultraviolet curing and may improve bending properties of the hard coating film, improve flexibility, and minimize curling.

Specific examples of the monofunctional (meth)acrylate include ethyl (meth)acrylate, methyl (meth)acrylate, 2-ethylhexyl (meth)acrylate, butyl (meth)acrylate, isobutyl (meth)acrylate, 2-ethoxyethyl (meth)acrylate, isodecyl (meth)acrylate, octyl (meth)acrylate, isooctyl (meth)acrylate, 2-methoxyethyl (meth)acrylate, isobornyl (meth)acrylate and the like.

The monofunctional (meth)acrylate may be contained in an amount of 5 to 10% by weight based on 100% by weight of the total weight of the first hard coating composition. When the amount of the monofunctional (meth)acrylate is less than 5% by weight, it may be difficult to impart flexibility, and when the amount of the monofunctional (meth)acrylate is more than 10% by weight, the hardness characteristics may be deteriorated.

In one embodiment of the present invention, the photopolymerization initiator is used for photocuring the first hard coating composition, and it may be used without particular limitation as long as it is an initiator being commonly used in the technical field.

The photopolymerization initiator can be classified into a Type I photopolymerization initiator in which radicals are generated by decomposition of molecules due to a difference in chemical structure or molecular binding energy, and a Type II (hydrogen abstraction type) photopolymerization initiator in which tertiary amines are incorporated as a co-initiator. Specific examples of the Type I photopolymerization initiator may include acetophenones such as 4-phenoxy dichloroacetophenone, 4-t-butyldichloroacetophenone, 4-t-butyltrichloroacetophenone, diethoxyacetophenone, 2-hydroxy-2-methyl-1-phenylpropan-1-one, 1-(4-isopropylphenyl)-2-hydroxy-2-methylpropan-1-one, 1-(4-dodecylphenyl)-2-hydroxy-2-methylpropan-1-one, 4-(2-hydroxyethoxy)-phenyl(2-hydroxy-2-propyl)ketone, 1-hydroxycyclohexyl phenyl ketone or the like, benzoins such as benzoin, benzoin methyl ether, benzoin ethyl ether, benzyl dimethyl ketal or the like, acylphosphine oxides, titanocene compounds, and the like. Specific examples of the Type II photopolymerization initiator may include benzophenones such as benzophenone, benzoyl benzoic acid, benzoyl benzoic acid methyl ether, 4-phenylbenzophenone, hydroxybenzophenone, 4-benzoyl-4′-methyldiphenylsulfide, 3,3′-methyl-4-methoxybenzophenone or the like, and thioxanthones such as thioxanthone, 2-chlorothioxanthone, 2-methylthioxanthone, 2,4-dimethylthioxanthone, isopropylthioxanthone or the like. These photopolymerization initiators may be used alone or in combination of two or more. In addition, the Type I photopolymerization initiator and the Type II photopolymerization initiator can be used together.

The photopolymerization initiator may be contained in an amount of 0.1 to 5% by weight, preferably 1 to 3% by weight based on 100% by weight of the total weight of the first hard coating composition. If the amount of the initiator is less than 0.1% by weight, the curing may not proceed sufficiently and thus the mechanical properties or adhesive force of the finally obtained coating film may be lowered. If the amount of the initiator is higher than 5% by weight, adhesion failure, or cracking and curling may occur due to the curing shrinkage.

In one embodiment of the present invention, the solvent may be used without particular limitation as long as it is a solvent being commonly used in this technical field.

Specific examples of the solvent may include alcohols such as methanol, ethanol, isopropanol, butanol, propylene glycol methoxy alcohol, etc.; ketones such as methyl ethyl ketone, methyl butyl ketone, methyl isobutyl ketone, diethyl ketone, dipropyl ketone, etc.; acetates such as methyl acetate, ethyl acetate, butyl acetate, propylene glycol methoxy acetate, etc.; cellosolves such as methyl cellosolve, ethyl cellosolve, propyl cellosolve, etc.; hydrocarbons such as n-hexane, n-heptane, benzene, toluene, xylene, etc.; and the like. These solvents may be used alone or in a combination of two or more.

The solvent may be contained in an amount of 5 to 90% by weight, preferably 10 to 85% by weight, based on 100% by weight of the total weight of the hard coating composition. If the amount of the solvent is less than 5% by weight, the viscosity may increase to deteriorate workability. If the amount of the solvent is higher than 90% by weight, it is difficult to adjust the thickness of the coating film, and drying unevenness may occur, resulting in appearance defects.

In one embodiment of the present invention, the first hard coating composition may further comprise inorganic particles to further improve the mechanical properties.

The inorganic particles may have an average particle diameter of 1 to 100 nm, preferably 5 to 50 nm. These inorganic particles are uniformly formed in the coating film and can improve mechanical properties such as abrasion resistance, scratch resistance and pencil hardness. If the particle diameter is less than the above range, agglomeration occurs in the composition and so a uniform coating film cannot be formed and the above effect cannot be expected. On the other hand, if the particle diameter exceeds the above range, not only the optical properties of the finally obtained coating film may be deteriorated, but also the mechanical properties may be deteriorated.

These inorganic particles can be metal oxides, and one selected from the group consisting of Al₂O₃, SiO₂, ZnO, ZrO₂, BaTiO₃, TiO₂, Ta₂O₅, Ti₃O₅, ITO, IZO, ATO, ZnO—Al, Nb₂O₃, SnO and MgO can be used. Particularly, Al₂O₃, SiO₂, ZrO₂ and the like can be used.

The inorganic particles can be produced directly or commercially available. In the case of commercially available products, those dispersed in an organic solvent at a concentration of 10 to 80% by weight can be used.

The inorganic particles may be contained in an amount of 5 to 50% by weight based on 100% by weight of the total weight of the first hard coating composition. When the amount of the inorganic particles is less than 5% by weight, the mechanical properties such as abrasion resistance, scratch resistance and pencil hardness may be insufficient, and when the amount of the inorganic particles exceeds 50% by weight, the curability is disturbed, which causes deterioration of mechanical properties, and results in appearance defects.

In one embodiment of the present invention, the first hard coating composition may further include components commonly used in the art, such as a leveling agent, a ultraviolet stabilizer, a heat stabilizer, and the like, in addition to the above-mentioned components

The leveling agent may be used in order to provide the smoothness and coating property of a coating film during coating of the composition. As the leveling agent, silicon-type, fluorine-type and acrylic polymer-type leveling agents being commercially available may be selected and used. For example, BYK-323, BYK-331, BYK-333, BYK-337, BYK-373, BYK-375, BYK-377, BYK-378, BYK-3570 (available from BYK Chemie), TEGO Glide 410, TEGO Glide 411, TEGO Glide 415, TEGO Glide 420, TEGO Glide 432, TEGO Glide 435, TEGO Glide 440, TEGO Glide 450, TEGO Glide 455, TEGO Rad 2100, TEGO Rad 2200N, TEGO Rad 2250, TEGO Rad 2300, TEGO Rad 2500 (available from Degussa), FC-4430 and FC-4432 (available from 3M), or the like may be used. The leveling agent may be contained in an amount of 0.1 to 1% by weight based on 100% by weight of the total weight of the first hard coating composition.

Since the surface of the cured coating film is decomposed by continuous ultraviolet ray exposure to be discolored and crumbled, the ultraviolet stabilizer may be added for the purpose of protecting the coating film by blocking or absorbing such ultraviolet rays. The ultraviolet stabilizer may be classified into an absorbent, a quencher, and a hindered amine light stabilizer (HALS) depending on the action mechanism. Also, it may be classified into phenyl salicylate (absorbent), benzophenone (absorbent), benzotriazole (absorbent), nickel derivative (quencher) and radical scavenger depending on the chemical structure. In one embodiment of the present invention, the ultraviolet stabilizer is not particularly limited as long as it does not significantly change the initial color of the coating film.

The heat stabilizer is a product that can be applied commercially, and a polyphenol type which is a primary heat stabilizer, a phosphite type which is a secondary heat stabilizer, and a lactone type can be used each individually or in combination thereof.

The ultraviolet stabilizer and the heat stabilizer can be used by appropriately adjusting the content thereof at a level that does not affect the ultraviolet curability.

The first hard coating composition may be coated onto the substrate film by suitably using a known coating process such as die coater, air knife, reverse roll, spray, blade, casting, gravure, micro gravure, spin coating, etc.

After the first hard coating composition is coated onto the substrate film, a drying process may be carried out by vaporizing volatiles at a temperature of 30 to 150° C. for 10 seconds to one hour, more specifically 30 seconds to 30 minutes, followed by UV curing. The UV curing may be carried out by the irradiation of UV-rays at about 0.01 to 10 J/cm², particularly 0.1 to 2 J/cm².

<Second Hard Coating Composition>

In one embodiment of the present invention, the second hard coating composition may include a photocurable epoxy resin, a photopolymerization initiator and a solvent,

In addition, the second hard coating composition may further include inorganic particles, and may further include additives such as a leveling agent, a ultraviolet stabilizer, a heat stabilizer and the like, if necessary.

The photocurable epoxy resin may include an alkoxysilane compound or polysiloxane resin having an epoxy group.

In one embodiment of the present invention, the alkoxysilane compound having an epoxy group may include a compound represented by the following chemical formula 3:

R⁷ₙSi(OR⁸)₄₋ₙ [Chemical Formula 3]

wherein, R⁷ is an epoxy group, R⁸ is a C₁-C₂₀ alkyl group, and n is an integer of 1 to 3.

The C₁-C₂₀ alkyl group as used herein refers to a linear or branched hydrocarbon having 1 to 20 carbon atoms, and examples thereof include methyl, ethyl, n-propyl, i-propyl, n-butyl, i-butyl, t-butyl, n-pentyl, n-hexyl, and the like, but are not limited thereto.

The alkoxysilane compound having an epoxy group performs a cationic photopolymerization reaction by the epoxy group. The cationic photopolymerization reaction exhibits relatively low shrinkage and does not cause oxygen inhibition reaction on the surface. Therefore, the stable curing is possible and the curing ratio is excellent. In addition, the polysiloxane resin produced by the sol-gel reaction of the alkoxysilane compound has characteristics that the cationic photopolymerization occurs rapidly and the curing ratio is excellent due to the existence of a siloxane network. Such alkoxysilane compound and polysiloxane resin having an epoxy group provide an excellent hardness to the hard coating composition and also simultaneously provide excellent flexibility.

The alkoxysilane compound having an epoxy group represented by the chemical formula 3 may be selected from the group consisting of 2-(3,4-epoxycyclohexyl)ethyltrimethoxysilane, 2-(3,4-epoxycyclohexyl)ethyltriethoxysilane, 3-glycidoxypropyl trimethoxysilane, and 3-glycidoxypropyl triethoxysilane.

The polysiloxane resin having an epoxy group can be produced by a hydrolysis sol-gel reaction of the alkoxysilane compound.

Specifically, an alkoxy group of the alkoxysilane as a starting material is hydrolyzed with water to form a hydroxyl group, and a siloxane bond is formed by a condensation reaction with an alkoxy group or a hydroxyl group of another alkoxysilane compound to form a polysiloxane.

Catalysts may be preferably introduced to facilitate the hydrolysis sol-gel reaction. Usable catalysts may include acid catalysts such as acetic acid, phosphoric acid, sulfuric acid, hydrochloric acid, nitric acid, chlorosulfonic acid, para-toluic acid, trichloroacetic acid, polyphosphoric acid, pyrophosphoric acid, iodic acid, tartaric acid, perchloric acid; base catalysts such as ammonia, sodium hydroxide, n-butylamine, di-n-butylamine, tri-n-butylamine, imidazole, ammonium perchlorate, potassium hydroxide, barium hydroxide; ion exchange resins such as Amberite IPA-400(C1), and the like. The amount of the catalyst to be used is not particularly limited, and it may be added in an amount of 0.0001 to 10 parts by weight based on 100 parts by weight of the alkoxysilane.

The hydrolysis sol-gel reaction can be carried out by stirring at room temperature for 6 to 144 hours, and may also be carried out at 60 to 80° C. for 12 to 36 hours to accelerate the reaction rate and perform the complete condensation reaction.

The alkoxysilane compound or the polysiloxane resin may be contained in an amount of 30 to 60% by weight, preferably 35 to 55% by weight, based on 100% by weight of the total weight of the second hard coating composition. When the amount of the alkoxysilane compound or the polysiloxane resin is lower than 30% by weight, it becomes difficult to secure hardness. When it is more than 60% by weight, the coating film is cracked and so it may become difficult to impart bending properties.

In one embodiment of the present invention, the photopolymerization initiator is used for photocuring the second hard coating composition, and any initiator may be used without particular limitation as long as it is an initiator being commonly used in the technical field.

As the photopolymerization initiator, a cationic photopolymerization initiator capable of initiating a polymerization reaction of a cationic photocurable component by generating cationic species or Lewis acids upon irradiation with an active energy ray such as visible light, ultraviolet light, X-rays, electron beams or the like can be used.

Since the cationic photopolymerization initiator acts catalytically by light, it is excellent in storage stability and workability even when mixed with a cationic photocurable component. Examples of the compounds that generate cationic species or Lewis acids upon irradiation with an active energy ray include an onium salt such as an aromatic diazonium salt, an aromatic iodonium salt or an aromatic sulfonium salt; iron-allene complex and the like. Among them, the aromatic sulfonium salt is preferable, since it has ultraviolet absorption properties even in the wavelength region around 300 nm, so that it has excellent curability and can impart excellent coating film characteristics. The cationic photopolymerization initiators may be used alone or in combination of two or more.

The photopolymerization initiator may be contained in an amount of 0.1 to 5% by weight based on 100% by weight of the total weight of the second hard coating composition. When the amount of the photopolymerization initiator is less than 0.1% by weight, the curing rate is slow, and when the amount of the photopolymerization initiator is more than 5% by weight, cracks may occur in the hard coating layer due to excessive curing.

The other components contained in the second hard coating composition, and the coating, drying and curing methods thereof are the same as those explained for the first hard coating composition, and so the description thereof is omitted in order to avoid duplication.

One embodiment of the present invention relates to an image display device having the above-described hard coating film. For example, the hard coating film of the present invention may be used as a window of the image display device, especially the flexible display. Further, the hard coating film of the present invention may be used by attaching to a polarizing plate, a touch sensor, or the like.

The hard coating film according to one embodiment of the present invention may be used in liquid crystal devices (LCDs) of various operation modes, including reflective, transmissive, transflective, twisted nematic (TN), super-twisted nematic (STN), optically compensated bend (OCB), hybrid-aligned nematic (HAN), vertical alignment (VA)-type and in-plane switching (IPS) LCDs. Also, the hard coating film according to one embodiment of the present invention may be used in various image display devices, including plasma displays, field emission displays, organic EL displays, inorganic EL displays, electronic paper and the like.

Hereinafter, the present invention will be described in more detail with reference to examples, comparative examples and experimental examples. It should be apparent to those skilled in the art that these examples, comparative examples and experimental examples are for illustrative purposes only, and the scope of the present invention is not limited thereto.

### Preparation Example 1: Preparation of First Hard Coating Composition

Based on 100% by weight of the total weight of the first hard coating composition, 40% by weight of a dendrimer compound having a terminal (meth)acrylate group (SP-1106, Miwon Specialty Chemicals), 5% by weight of monofunctional acrylate (butyl acylate), 39% by weight of inorganic silica particles (particle diameter of 10-15 nm), 2.5% by weight of photopolymerization initiator (1-hydroxycyclohexyl phenyl ketone), 0.5% by weight of a leveling agent (BYK-3570, BYK Chemie) and 13% by weight of a solvent (methyl ethyl ketone) were mixed using a stirrer and then filtered using a polypropylene (PP) filter to prepare a first hard coating composition.

### Preparation Example 2: Preparation of Second Hard Coating Composition

Based on 100% by weight of the total weight of the second hard coating composition, 40% by weight of a polysiloxane resin (SP-3T, Shin-A T & C), 5% by weight of inorganic silica particles (particle diameter of 10-15 nm), 2.5% by weight of a photopolymerization initiator (bis(4-methylphenyl)iodonium hexafluorophosphate), 0.5% by weight of a leveling agent (BYK-3570, BYK Chemie) and 52% by weight of a solvent (methyl ethyl ketone) were mixed using a stirrer and then filtered using a polypropylene (PP) filter to prepare a second hard coating composition.

### Examples 1 to 3 and Comparative Examples 1 to 2: Preparation of Hard Coating Film

### Example 1

The first hard coating composition prepared in Preparation Example 1 was coated on one surface of an optical polyimide film (100 μm) as a substrate so as to have a thickness of 5 μm after drying, dried in a 80° C. oven for 5 minutes and then irradiated with UV light of 0.5 J/cm² in a high pressure mercury lamp to form a first hard coating layer. Thereafter, the second hard coating composition prepared in Preparation Example 2 was coated on the first hard coating layer so as to have a thickness of 5 μm after drying, dried in a 80° C. oven for 5 minutes, and then irradiated with UV light of 0.5 J/cm² in a high pressure mercury lamp to form a second hard coating layer. Thereby, the hard coating film was prepared.

### Example 2

The hard coating film was prepared in the same manner as in Example 1, except that the first hard coating composition prepared in Preparation Example 1 was coated on one surface of the substrate so as to have a thickness of 7 μm after drying, and the second hard coating composition prepared in Preparation Example 2 was coated on the first hard coating layer so as to have a thickness of 3 μm after drying to form a second hard coating layer.

### Example 3

The hard coating film was prepared in the same manner as in Example 1, except that the first hard coating composition prepared in Preparation Example 1 was coated on one surface of the substrate so as to have a thickness of 3 μm after drying, and the second hard coating composition prepared in Preparation Example 2 was coated on the first hard coating layer so as to have a thickness of 7 μm after drying to form a second hard coating layer.

### Comparative Example 1

The hard coating film was prepared in the same manner as in Example 1, except that the first hard coating composition prepared in Preparation Example 1 was coated on one surface of the substrate so as to have a thickness of 5 μm after drying, and the first hard coating composition prepared in Preparation Example 1 was coated on the first hard coating layer so as to have a thickness of 5 μm after drying to form a second hard coating layer.

### Comparative Example 2

The hard coating film was prepared in the same manner as in Example 1, except that the second hard coating composition prepared in Preparation Example 2 was coated on one surface of the substrate so as to have a thickness of 5 μm after drying, and the second hard coating composition prepared in Preparation Example 2 was coated on the first hard coating layer so as to have a thickness of 5 μm after drying to form a second hard coating layer.

### Experimental Example 1

### Experimental Example 1-1

The first hard coating composition prepared in Preparation Example 1 was coated on one surface of an optical polyimide film (100 μm) as a substrate so as to have a thickness of 3 μm after drying, dried in a 80° C. oven for 5 minutes and then irradiated with UV light of 0.5 J/cm² in a high pressure mercury lamp to form only a first hard coating layer on the substrate film, thereby obtaining a first hard coating film.

The curl value was obtained by cutting the hard coating film into a size of 10 cm×10 cm, leaving to stand under conditions of 25° C. and 48 RH % for 24 hours, placing the film on a flat glass plate so that the convex surface thereof is in contact with the glass plate, and then measuring the average of the heights from the bottom of the glass plate (reference surface) to four edges. The positive curl was represented by (+) value, and the reverse curl was represented by (−) value.

The measured curl value was 3 mm.

### Experimental Example 1-2

The hard coating film was prepared m the same manner as in Experiment Example 1-1, except that the first hard coating composition was coated so as to have a thickness of 5 Ξm after driving, and the curl value thereof was measured.

The measured curl value was 5 mm.

### Experimental Example 1-3

The hard coating film was prepared in the same manner as in Experiment Example 1-1, except that the first hard coating composition was coated so as to have a thickness of 7 μm after drying, and the curl value thereof was measured.

The measured curl value was 7 mm.

### Experimental Example 1-4

The hard coating film was prepared in the same manner as in Experiment Example 1-1, except that the second hard coating composition was used instead of the first hard coating composition, and the curl value thereof was measured.

The measured curl value was −10 mm.

### Experimental Example 1-5

The hard coating film was prepared m the same manner as in Experiment Example 1-2, except that the second hard coating composition was used instead of the first hard coating composition, and the curl value thereof was measured.

The measured curl value was −15 mm.

### Experimental Example 1-6

The hard coating film was prepared in the same manner as in Experiment Example 1-3, except that the second hard coating composition was used instead of the first hard coating composition, and the curl value thereof was measured.

The measured curl value was −20 mm.

### Experimental Example 2

The physical properties of the hard coating films prepared in Examples and Comparative Examples were each measured by the methods described below, and the results are shown in Table 1 below.

(1) Bending Resistance at Room Temperature

The hard coating film (width×length=10 mm×100 mm) was folded in half so that the distance between the film surfaces was 6 mm. Then, when the film was spread again, it was confirmed with the naked eye whether or not cracks occurred at the folded portion, and thereby the bending resistance at room temperature was evaluated.

<Evaluation Criteria>

⊚: No crack occurred at the folded portion

◯-A: Cracks occurred at the folded portion (the length was equal to or less than 5 mm, and the number was equal to or less than 5)

◯-B: Cracks occurred at the folded portion (the length was equal to or less than 5 mm, and the number was greater than 5 and equal to or less than 10)

◯-C: Cracks occurred at the folded portion (the length was equal to or less than 5 mm, and the number was greater than 10)

Δ-A: Cracks occurred at the folded portion (the length was greater than 5 mm and equal to or less than 10 mm, and number was equal to or less than 5)

Δ-B: Cracks occurred at the folded portion (the length was greater than 5 mm and equal to or less than 10 mm, and number was greater than 5 and equal to or less than 10)

Δ-C: Cracks occurred at the folded portion (the length was greater than 5 mm and equal to or less than 10 mm, and number was greater than 10)

x: breakage occurred at the folded portion

(2) Bending Resistance at High Temperature-High Humidity

The hard coating film (width×length=10 mm×100 mm) was folded in half so that the distance between the film surfaces was 6 mm, and then left to stand under conditions of 85° C. and 85% relative humidity for 24 hours. Then, when the film was spread again, it was confirmed with the naked eye whether or not cracks occurred at the folded portion, and thereby the bending resistance was evaluated.

<Evaluation Criteria>

⊚: No crack occurred at the folded portion

◯-A: Cracks occurred at the folded portion (the length was equal to or less than 5 nm, and the number was equal to or less than 5)

◯-B: Cracks occurred at the folded portion (the length was equal to or less than 5 nm, and the number was greater than 5 and equal to or less than 10)

◯-C: Cracks occurred at the folded portion (the length was equal to or less than 5 mm, and the number was greater than 10)

Δ-A: Cracks occurred at the folded portion (the length was greater than 5 mm and equal to or less than 10 mm, and number was equal to or less than 5)

Δ-B: Cracks occurred at the folded portion (the length was greater than 5 mm and equal to or less than 10 mm, and number was greater than 5 and equal to or less than 10)

Δ-C: Cracks occurred at the folded portion (the length was greater than 5 mm and equal to or less than 10 mm, and number was greater than 10)

x: breakage occurred at the folded portion

(3) Pencil Hardness

The pencil hardness was measured by applying a load of 500 g using a pencil hardness tester (PHT, Korea Sukbo Science). A pencil manufactured by Mitsubishi Corporation was used and the measurements were performed five times for each pencil hardness. When two or more scratches were found, it was determined to be defective, and the maximum hardness determined as OK was recorded.

(4) Curl

The hard coating films prepared in Examples and Comparative Examples were cut into a size of 10 cm×10 cm, left to stand under conditions of 25° C. and 48 RH % for 24 hours, and then placed on a flat glass plate so that the convex surface thereof was in contact with the glass plate. Then, the curl value was obtained by measuring the average of the heights from the bottom of the glass plate (reference surface) to four edges. The results were recorded in accordance with the following evaluation criteria.

<Evaluation Criteria>
⊚: Average height of four edges was equal to or less than 20 mm
◯: Average height of four edges was greater than 20 mm and equal to or less than 50 mm
Δ: Average height of four edges was greater than 50 mm
X: Four edges were completely lifted, and the film was curled in a cylindrical shape

(5) Scratch Resistance

The scratch resistance was tested by reciprocating 10 times under a load of 1 kg/(2 cm×2 cm) using a steel wool tester (WT-LCM100, Korea Protec). The steel wool used was #0000.

<Evaluation Criteria>
S: 0 scratch
A: 1 to 10 scratches
B: 11 to 20 scratches
C: 21 to 30 scratches
D: Equal to or more than 31 scratches

TABLE 1

| | | Bending | | | | |
|---|---|---|---|---|---|---|
| | Bending | resistance at | | | | |
| | resistance | high | | | | |
| | at room | temperature- | Pencil | | | Scratch |
| | tem- | high | Hard- | | | re- |
| | perature | humidity | ness | Curl | | sistance |
| Example 1 | ⊚ | ⊚ | 3H | AB <0 | ⊚ | A |
| Example 2 | ⊚ | ⊚ | 3H | AB <0 | ⊚ | A |
| Example 3 | ◯-A | ◯-A | 3H | AB <0 | ⊚ | A |
| Comparative | Δ-B | Δ-C | 3H | AB >0 | X | C |
| Example 1 | | | | | | |
| Comparative | Δ-B | X | 3H | AB >0 | X | C |
| Example 2 | | | | | | |

As can be seen from Table 1, the hard coating films of Examples 1 to 3 according to the present invention not only had excellent bending resistance and scratch resistance, but also suppressed the occurrence of curling. On the other hand, the hard coating films of Comparative Examples 1 and 2 were found to be poor in bending resistance, scratch resistance and curl characteristics.

Although particular embodiments of the present invention have been shown and described in detail, it will be obvious to those skilled in the art that these specific techniques are merely preferred embodiments and the scope of the invention is not limited thereto. It will be understood by those skilled in the art that various changes and modifications may be made to the invention without departing from the spirit and scope of the invention.

The substantial scope of the present invention, therefore, is to be defined by the appended claims and equivalents thereof.

1. A hard coating film in which a first hard coating layer and a second hard coating layer are laminated on one side of a substrate film, wherein, AB<0 when the curl values of the first hard coating layer and the second hard coating layer are A and B, respectively.

2. The hard coating film of claim 1, wherein the first hard coating layer and the second hard coating layer have a thickness of 1 to 10 μm, respectively.

3. The hard coating film of claim 1, wherein the first hard coating layer is formed from a first hard coating composition including a photocurable acrylic resin, a photopolymerization initiator and a solvent, and
the second hard coating layer is formed from a second hard coating composition including a photocurable epoxy resin, a photopolymerization initiator and a solvent.

4. The hard coating film of claim 3, wherein the first hard coating layer is formed from a first hard coating composition including a dendrimer compound having a terminal (meth)acrylate group, a monofunctional (meth)acrylate, a photopolymerization initiator and a solvent, and
the second hard coating layer is formed from a second hard coating composition including an alkoxysilane compound or polysiloxane resin having an epoxy group, a photopolymerization initiator, and a solvent.

5. The hard coating film of claim 3, wherein the first hard coating composition and the second hard coating composition further comprise inorganic particles.

6. The hard coating film of claim 1, wherein the curl value of the first hard coating layer is (+) and the curl value of the second hard coating layer is (−).

7. An image display device having the hard coating film of claim 1.

8. A window of a flexible display device having the hard coating film of claim 1.

9. A polarizing plate having the hard coating film of claim 1.

10. A touch sensor having the hard coating film of claim 1.

11. An image display device having the hard coating film of claim 2.

12. An image display device having the hard coating film of claim 3.

13. An image display device having the hard coating film of claim 4.

14. An image display device having the hard coating film of claim 5.

15. An image display device having the hard coating film of claim 6.

16. A window of a flexible display device having the hard coating film of claim 2.

17. A window of a flexible display device having the hard coating film of claim 3.

18. A window of a flexible display device having the hard coating film of claim 4.

19. A window of a flexible display device having the hard coating film of claim 5.

20. A window of a flexible display device having the hard coating film of claim 6.
